(19) United States
(12) Patent Application Publication
(10) Pub. No.: US 2013/0265853 A1
(43) Pub. Date: Oct. 10, 2013

(54) SEISMIC DATA ACQUISITION IN A WIRELESS ARRAY WITH RAPID SOURCE EVENTS

(71) Applicant: WIRELESS SEISMIC, INC., Louisville, CO (US)

(72) Inventors: Garrick Wager, Arvada, CO (US); Manbro Lee, Sugar Land, TX (US); Martin Nurre, Richmond, TX (US)

(73) Assignee: Wireless Seismic, Inc., Louisville, CO (US)

(21) Appl. No.: 13/859,400

(22) Filed: Apr. 9, 2013

Related U.S. Application Data
(60) Provisional application No. 61/621,925, filed on Apr. 9, 2012.

(51) Int. Cl. G01V 1/22

(52) U.S. Cl. CPC G01V 1/223
USPC 367/77

(57) ABSTRACT

A data collection system that is operable to read out seismic data collected at wireless acquisition modules in response to source events such that the progression of subsequent source events occurs prior to the complete data record for a prior source event being collected at a data collection unit. The system may include mechanisms by which the source event progression is only interrupted based on a detected potential for loss of data integrity.

### CROSS-REFERENCE TO RELATED APPLICATION

This application is a non-provisional of U.S. Patent Provisional Application No. 61/621,925, entitled: “SEISMIC DATA ACQUISITION IN A WIRELESS ARRAY WITH RAPID SOURCE EVENTS” filed on Apr. 9, 2012. The contents of the above application are incorporated by reference herein as if set forth in full.

### BACKGROUND

Seismic surveys are often used by natural resource exploration companies and other entities to create images of subsurface geologic structure. These images are used to determine the optimum places to drill for oil and gas and to plan and monitor enhanced resource recovery programs among other applications. Seismic surveys may also be used in a variety of contexts outside of oil exploration such as, for example, locating subterranean water and planning road construction.

A seismic survey is normally conducted by placing an array of vibration sensors (accelerometers or velocity sensors called “geophones”) on the ground, typically in a line or in a grid of rectangular or other geometry. Vibrations are created by an energy source such as, for example, explosives or a mechanical device such as a vibrating energy source or a weight drop. The creation of vibrations by the vibration source may be referred to as a source event. Multiple source events may be used for some surveys. The vibrations from the source events propagate through the earth, taking various paths, refracting and reflecting from geological features such as discontinuities in the subsurface, and are detected by the array of vibration sensors. Signals from the sensors are amplified and digitized, either by separate electronics or internally in the case of “digital” sensors.

The digital data from a multiplicity of sensors is eventually recorded on storage media, for example magnetic tape, or magnetic or optical disks, or other memory device, along with related information pertaining to the survey. The survey may include multiple source events and/or the active sensors that may move such that the process is continued until a multiplicity of seismic records is obtained for a number of source events to comprise a seismic survey. Data from the survey are processed on computers to create the desired information about subsurface geologic structure.

In general, as more sensors are used, placed closer together, and/or cover a wider area, the quality of the resulting image will improve. It has become common to use thousands of sensors in a seismic survey stretching over an area measured in square kilometers. Accordingly, hundreds of kilometers of cables may be laid on the ground and used to connect these sensors. Large numbers of workers, motor vehicles, and helicopters are typically used to deploy and retrieve these cables. Exploration companies would generally prefer to conduct surveys with more sensors located closer together. However, additional sensors require even more cables and further raise the cost of the survey. Economic tradeoffs between the cost of the survey and the number of sensors generally demand compromises in the quality of the survey.

In addition to the logistic costs, cables connecting sensors create reliability problems. Besides normal wear-and-tear from handling, they are often damaged by animals, vehicles, lightning strikes, and other problems. Considerable field time is expended troubleshooting cable problems. The extra logistics effort also adds to the environmental impact of the survey, which, among other things, adds to the cost of a survey or eliminates surveys in some environmentally sensitive areas.

As a result, wireless acquisition units have been developed to do away with the burdensome nature of cables in such a system. For instance, U.S. Pat. No. 7,773,457, which is incorporated by reference, describes a system for performing a seismic survey using wireless acquisition units.

### SUMMARY

In light of the foregoing, a number of aspects are presented herein. A first aspect includes a method for seismic data acquisition that includes disposing, in series, a plurality of seismic data acquisition modules that are operative to wirelessly communicate acquired seismic data. The acquisition modules define a wireless serial data transfer path for relaying data from upstream acquisition modules to downstream acquisition modules and a data collection unit. The method also includes creating a first source event and acquiring first seismic data corresponding to the first source event at the plurality of seismic data acquisition modules to generate a first data record. The first data record comprising first seismic data collected at each one of the plurality of seismic data acquisition modules. The method further includes transmitting the first seismic data from at least one module on the serial data transfer path in a direction nearer the data collection unit. The method further includes initiating a second source event, wherein the second source event occurs independent of the receipt of the first data record at the data collection unit.

A number of feature refinements and additional features are applicable to the first aspect. These feature refinements and additional features may be used individually or in any combination. As such, each of the following features that will be discussed may be, but are not required to be, used with any other feature or combination of features of the first aspect.

For instance, the second source event may occur prior to receipt of the entire first data record at the data collection unit. In this regard, the method may include continuing a source event progression of a plurality of sequential source events, wherein each source event in the source event progression occurs independent of the receipt of a data record corresponding to a previous source event in the source event progression at the data collection unit.

In an embodiment, the method may include interrupting the source event progression in response to an interrupt condition. The plurality of data acquisition modules may record the first seismic data in a data buffer at each respective acquisition module. The transmitting may comprise providing status information regarding the data buffer. As such, the interrupt condition may be at least partially based on the buffer status information.

In this regard, the method may include retransmitting the first seismic data from at least one module on the serial data transfer path in a direction nearer the data collection unit at some time after the transmitting step. For instance, the retransmitting step may be in response to a request for the first seismic data.

A second aspect includes a seismic survey system that includes a data collection unit and a plurality of data acquisition modules disposed in series that are operative to wirelessly communicate acquired seismic data. The acquisition modules define a wireless serial data transfer path for relaying the seismic data from upstream acquisition modules to downstream acquisition modules and the data collection unit; The system may also include an acquisition system controller in operative communication with the plurality of data acquisition modules and a source event controller operable to control the initiation of a plurality of source events, wherein the source event controller is in operative communication with the acquisition system controller to synchronize the acquisition system controller and the source event controller. The plurality of acquisition modules are operable to record seismic data corresponding to a source event initiated by the source event controller and initiate transmission of the seismic data along the serial transfer path toward the data collection unit, wherein the seismic data collectively comprises a seismic record corresponding to the seismic data recorded at each of the plurality of acquisition modules for the source event. Additionally, the source event controller may be operable to initiate another source event independent from receipt of the seismic record corresponding to the source event at the data collection unit.

A number of feature refinements and additional features are applicable to the second aspect. These feature refinements and additional features may be used individually or in any combination. For instance, each of the features discussed above regarding the first aspect may be, but are not required to be, used with any other feature or combination of features of the second aspect.

A third aspect includes a method of conducting a seismic survey that includes disposing, in series, a plurality of seismic data acquisition modules that are operative to wirelessly communicate acquired seismic data, wherein the acquisition modules define a wireless serial data transfer path for relaying data from upstream acquisition modules to downstream acquisition modules and a data collection unit. The method also includes initiating a source event progression, wherein the source event progression includes a plurality of source events activated in sequence independent of data acquisition by the plurality of modules. The method also includes collecting seismic data at the plurality of seismic data acquisition modules during the source event progression, wherein the seismic data corresponding to the plurality of source events is transmitted along the serial data transfer path nearer the data collection unit. Furthermore, the method includes interrupting the source event progression in response to an indication of loss of data integrity.

A number of feature refinements and additional features are applicable to the third aspect. These feature refinements and additional features may be used individually or in any combination. For instance any of the foregoing features discussed in relation to the first aspect may be, but are not required to be, used with any other feature or combination of features of the third aspect.

### BRIEF DESCRIPTION OF THE DRAWINGS

FIG. 1 is a schematic view of an embodiment of a seismic data acquisition module.

FIG. 2 is a schematic view of an embodiment of a seismic survey system.

FIGS. 3-4 are schematic views of an embodiment of a seismic survey system as deployed in a survey area at different respective times.

FIGS. 5A-5C are schematic views of an embodiment of a seismic survey system at different respective times including details regarding the transmission of data between modules in the system.

FIG. 6 is a schematic view of the embodiment of FIGS. 3-4 in an error state.

FIG. 7 is a schematic view of the embodiment of FIG. 6 after the error state has been resolved.

### DETAILED DESCRIPTION

The following description is not intended to limit the invention to the form disclosed herein. Consequently, variations and modifications commiserate with the following teachings, skill, and other knowledge of the relevant art, are within the scope of the present invention. The embodiments described herein are further intended to explain modes known of practicing the invention and to enable others skilled in the art to utilize the invention in such, or other embodiments, and with various modifications required by the particular application(s) or use(s) of the invention.

The present disclosure relates generally to seismic survey systems that may be used in the collection of seismic data in response to a plurality of source events. As used herein, a source event may refer to the creation of seismic vibrations that may propagate through the ground. In response to the propagation of seismic vibrations through the ground, at least a portion of the seismic energy may be returned to the surface (e.g., as a result of reflection or refraction) from various subsurface geological features. This returned seismic energy may be recorded by a plurality of seismic acquisition modules.

In traditional wired seismic systems, the seismic data collected by the modules in the array is read out via the communication cables in substantially real time. That is, almost instantaneously the seismic record (i.e., all data for a given source event from all of the modules in the array) is received in substantially real time. Accordingly, the speed at which the source events are created is dictated mostly by the time it takes to prepare and initiate the source events.

However, increasingly, wireless data acquisition and relay modules are replacing the conventional wired units. For example, a wireless data acquisition system may be provided in accord with U.S. Pat. No. 7,773,457, which is incorporated by reference.

In addition, a number of wireless systems have been proposed that are “blind” read out systems. That is, the modules for such systems record the seismic data in a memory at each module, which must then be read out after the source events. In this regard, problems with the data collected by the modules may not be realized prior to the data collection, which may require reacquisition of data that can add time and cost to the survey.

Other previously contemplated wireless survey systems may include a delay between acquisition of data and receipt at a central recording unit. In this regard, to preserve data integrity of these prior systems, a subsequent source event may be delayed until all data from a previous source event has been received from the modules in the array. In that the bandwidth available to wireless systems is generally much less than that available in wired systems, this may add time between source events. For example, in a crew responsible for initiating source events may be forced to wait at the location of the prior source event while data is collected and analyzed before moving to the location for a subsequent source event.

It is against this backdrop that the survey systems described herein have been developed. The survey systems described herein may allow for source event generation to proceed without delay without requiring the entire record for a previous source event be collected from the modules. In this regard, the survey systems described herein may have features that preserve data integrity. As such, the progression of source events may proceed uninhibited by the speed at which data can be read out from the modules in the array. Furthermore, as the data read out is divorced from the source event schedule, data read out may occur at a substantially different time than acquisition (e.g., to take advantage of favorable conditions for data read out in a time non-overlapping with the generation of source events such as during off-peak times with reduced cost for data transmission on a network). The present disclosure generally describes embodiments of modules that may be used in conjunction with rapidly occurring source events. Thereafter, one embodiment of typical operation of a survey system that includes rapidly occurring source events is described. Furthermore, various embodiments of fault events and mechanisms for preserving data integrity are described.

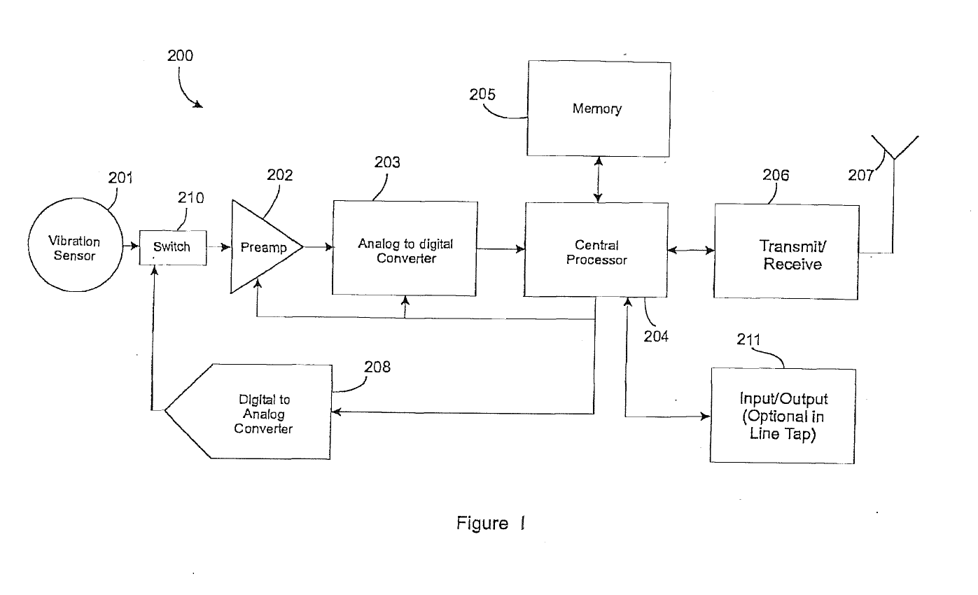

Turning to FIG. 1, a block diagram of an embodiment of a wireless remote acquisition and relay module 200 is shown that may be employed in a seismic survey system as described herein. A vibration sensor 201 may convert vibrations into electrical signals which are fed through switch 210 to preamplifier 202 and thence to the analog to digital (A/D) converter 203. The digital data from the A/D converter 203 may be fed into the Central Processor 204 or directly into a digital memory 205. Alternately, in the case of a sensor 201 with direct digital output, the signals may flow directly to the processor 204 or memory 205.

In addition to controlling the system and storing the data in the memory, the processor 204 may perform some calculations on the data including decimation, filtering, stacking repetitive records, correlation, timing, etc. The remote module 200 may also receive information through the transceiver 206, for example: timing information, cross-correlation reference signals, acquisition parameters, test and programming instructions, location information, seismic data from upstream modules and updates to the software, among other commands. The transmit and receive signals couple through antenna 207.

The processor 204 can control the transceiver 206, including transmit/receive status, frequencies, power output, and data flow as well as other functions required for operation. The remote module 200 can also receive data and commands from another remote module or base station, store them in the memory, and then transmit them again for reception by another remote module up or down the line.

In one embodiment, the module 200 may be operable to both store seismic data received from the vibration sensor 201 as well as transmit the seismic data to another module or central recording unit. In this regard, the memory 205 may be a data buffer that continually records new data into the buffer while deleting the oldest data from the buffer to free memory space for newly received data. The memory 205 may be sufficient to hold a relatively large amount of data (e.g., approaching or equaling the amount of memory space that would be required to capture the entire survey in memory). For example, the memory 205 may be operable to hold in a data buffer at least about 60 minutes of a seismic data record, or more.

A digital-to-analog (D/A) converter 208 may be included in the system which can accept digital data from the processor 204 to apply signals through a switch 210 to the input circuitry. These signals, which may for example consist of DC voltages, currents, or sine waves, can be digitized and analyzed to determine if the system is functioning properly and meeting its performance specifications. Typical analysis might include input noise, harmonic distortion, dynamic range, DC offset, and other tests or measurements. Signals may also be fed to the sensor 201 to determine such parameters as resistance, leakage, sensitivity, damping and natural frequency. The power supply voltage may also be connected through the switch 210 to the A/D converter 203 to monitor battery charge and/or system power. The preamplifier 202 may have adjustable gain set by the processor 204 or other means to adjust for input signal levels. The vibration sensor 201 may be a separate generic unit external to the remote module 200 and connected by cables, or the sensor 201 might be integral to the remote module package.

If the remote module 200 is to be used as a base station, equivalent to a “line-tap” or interface to the central recording system, it will also have a digital input/output function 211 which may be, for example, an Ethernet, USB, fiber-optic link, or some computer compatible wireless interface (e.g., one of the IEEE 802.11 standards) or another means of communication through a wired or radio link. It may be acceptable to use larger battery packs for the line tap wireless data acquisition and relay modules because they will normally be relatively few in number and may communicate over greater distances using a high speed data communication protocol.

The remote module 200 may be constructed of common integrated circuits available from a number of vendors. The Transmit/Receive integrated circuit 206 could be a digital data transceiver with programmable functions including power output, timing, frequency of operation, bandwidth, and other necessary functions. The operating frequency band may preferably be a frequency range which allows for unlicensed operation worldwide, for example, the 2.4 GHz range. The Central Processor 204, Memory 205, and switch 210 can include any of a number of generic parts widely available. The A/D converter 203 could preferably be a 24-bit sigma delta converter such as those available from a number of vendors. The preamplifier 202 should preferably be a low-noise, differential input amplifier available from a number of sources, or alternatively integrated with the A/D converter 203. The D/A converter 208 should preferably be a very low distortion unit which is capable of producing low-distortion sine waves which can be used by the system to conduct harmonic distortion tests. The module 200 may include a number of other components not shown in FIG. 1, such as a directional antennae for AOA signal measurements, separate transmit and receive antennae, separate antennae for location signals and seismic data transfer signals, GPS receivers, batteries, etc.

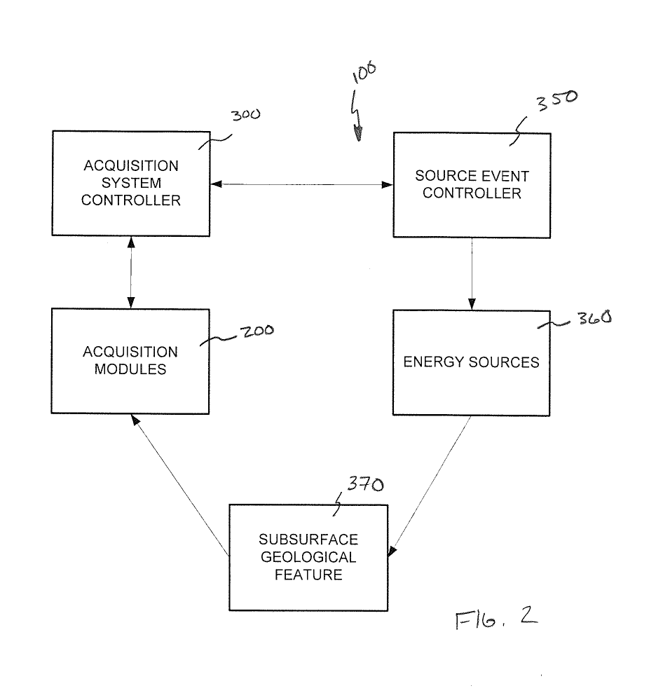

Turning to FIG. 2, a schematic view of an embodiment of a survey system 100 is shown. The survey system 100 may include an acquisition system controller 300. The acquisition system controller 300 may be in operative communication with a plurality of acquisition modules 200 (e.g., each of which corresponds to a module 200 described above with respect to FIG. 1). In this regard, the acquisition system controller 300 may be operative to receive transmitted seismic data from the modules 200 as well as communicate command signals (e.g., timing signals, programming instructions, requests for data, etc.) to the modules 200.

The acquisition system controller 300 may also be in communication with a source event controller 350. The communication between the acquisition system controller 300 an the source event controller 350 may include, for example, information related to timing, system operation parameters, system statues, etc. For example, the acquisition system controller 300 and the source event controller 350 may share a timing signal. In this regard, the timing of initiation of source events and data acquisition may be synchronized such that data corresponding to the source events can be accurately analyzed. Furthermore, the acquisition system controller 300 may transmit an interrupt condition to the source event controller 350 to interrupt or delay source events (e.g., in response to a sensed condition warranting an interrupt condition as will be discussed in greater detail below).

The source event controller 350 may be in operative communication with a plurality of energy sources 360, which may be activated to create a source event. Upon creation of a source event at an energy source 360, seismic energy may be transmitted through the ground and contact subsurface geological features 370. A portion of the seismic energy that is affected by the subsurface geological feature 370 (e.g., reflected or refracted energy) may be collected by the acquisition modules 370.

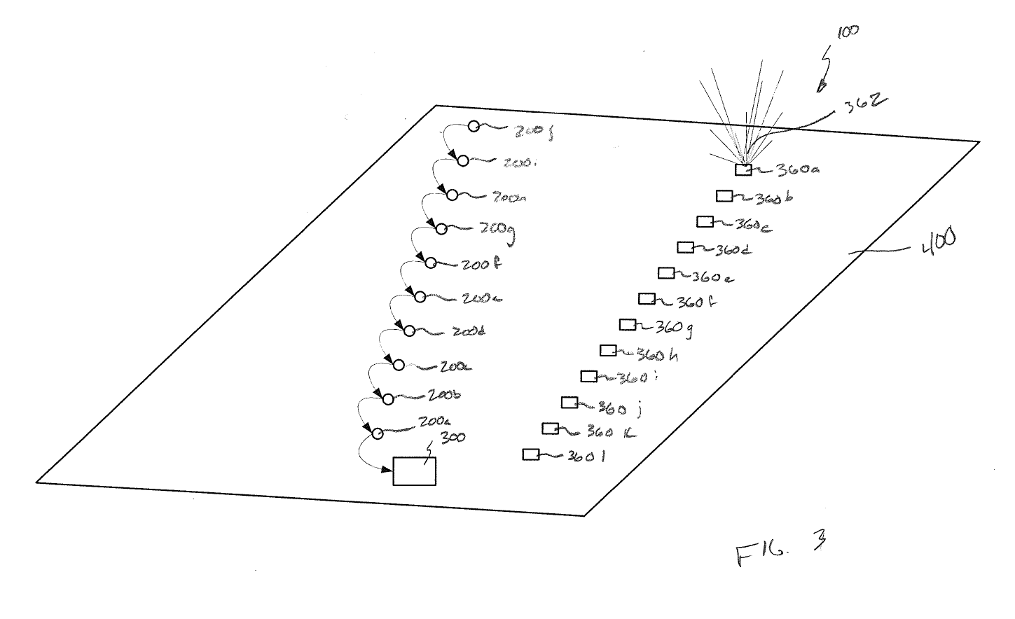

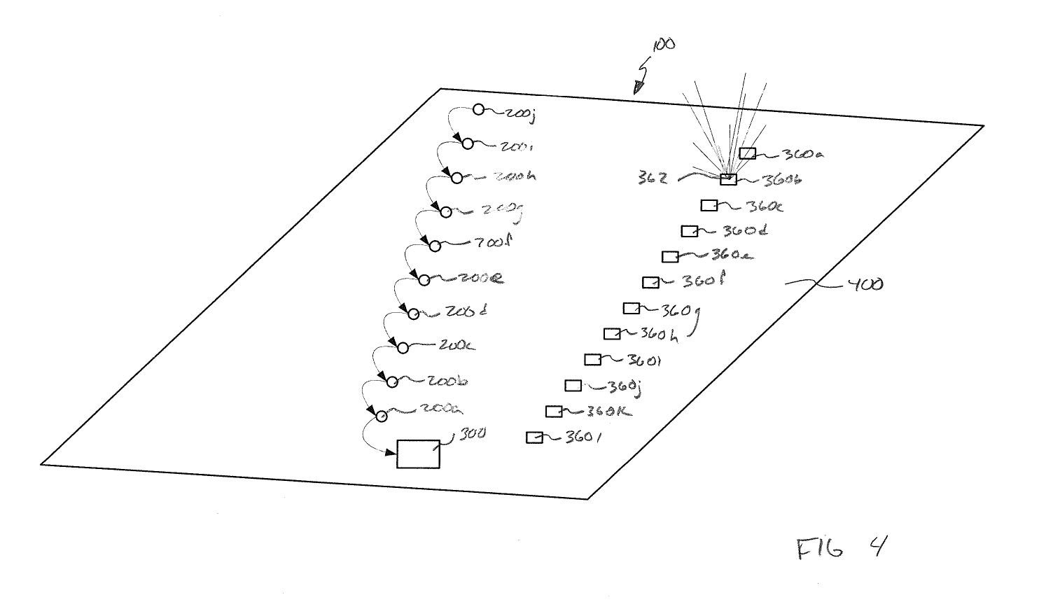

FIG. 3 depicts an embodiment of the survey system 100. The survey system may include an acquisition system controller 300 that is an operative communication with a plurality of acquisition modules 200a-200j that have been deployed into a survey area 400. Additionally, the survey system 100 includes a plurality of energy sources 360a-360l capable of generating source events 362. The source event 362 is depicted as an explosion at energy source 360a in FIG. 3. However, it will be understood the source event 362 may be in another form of a seismic energy generating event such as, for example, a vibration or weight drop. Furthermore, while a plurality of distinct energy sources 360a-360l are shown, it will be appreciated that a single energy source that is transported to each location represented by energy sources 360a-3601 may also be used. In this regard, FIG. 3 depicts the survey system at a first time during which energy source 360a is activated to generate a source event 362 and FIG. 4 depicts another time during which energy source 360b is activated to generate a source event 362.

Furthermore, as depicted in FIGS. 3 and 4, the acquisition modules 200a-200j may transmit seismic data to the acquisition system controller 300. In this regard, it will be understood that each acquisition module 200 may transmit seismic data recorded at the module 200 to an upstream module that in turn passes the data along a serial data transmission path created among the modules.

In one particular embodiment, the modules 200 may include a half duplex scheme in which half the time a module is listening to an upstream module and half the time a module is transmitting to a downstream module. Multiplexing schemes may be employed to allow for multiple modules to transmit in the serial data path at the same time. Furthermore, a module may receive data from an upstream module, append additional seismic data (e.g., data recorded at the module receiving data) and transmit the combined data to a downstream module.

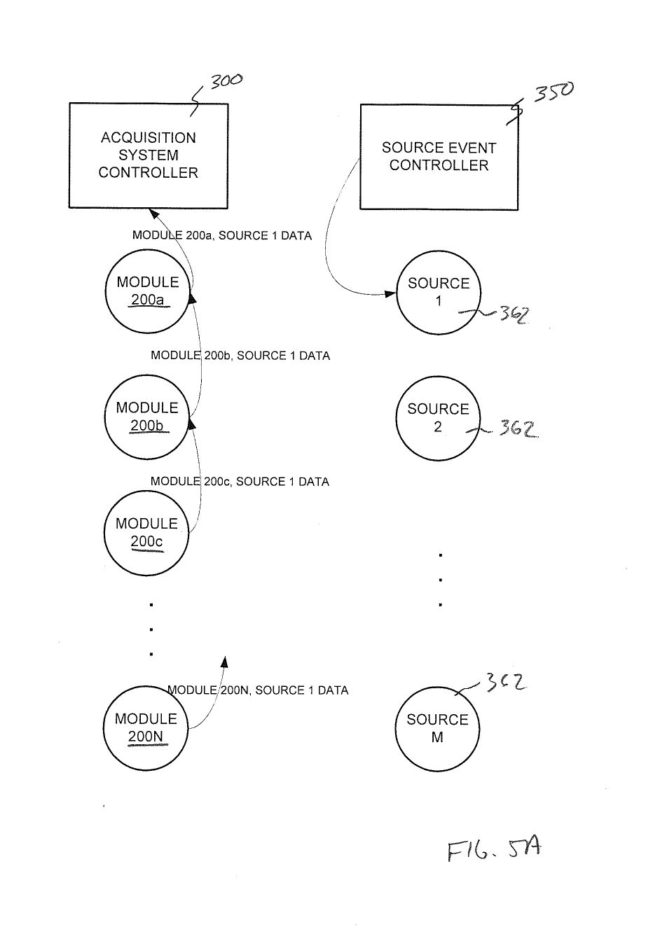

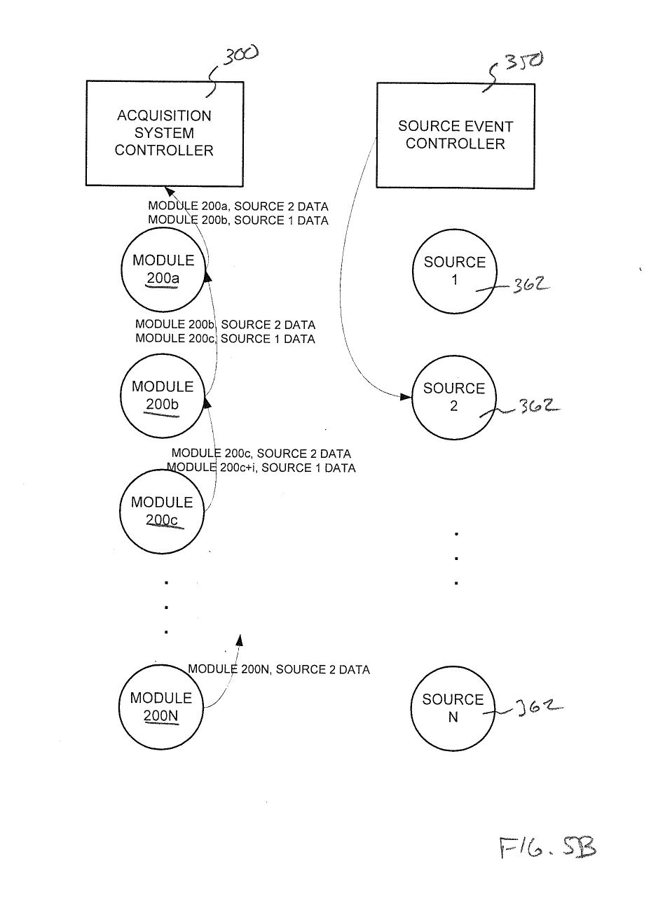

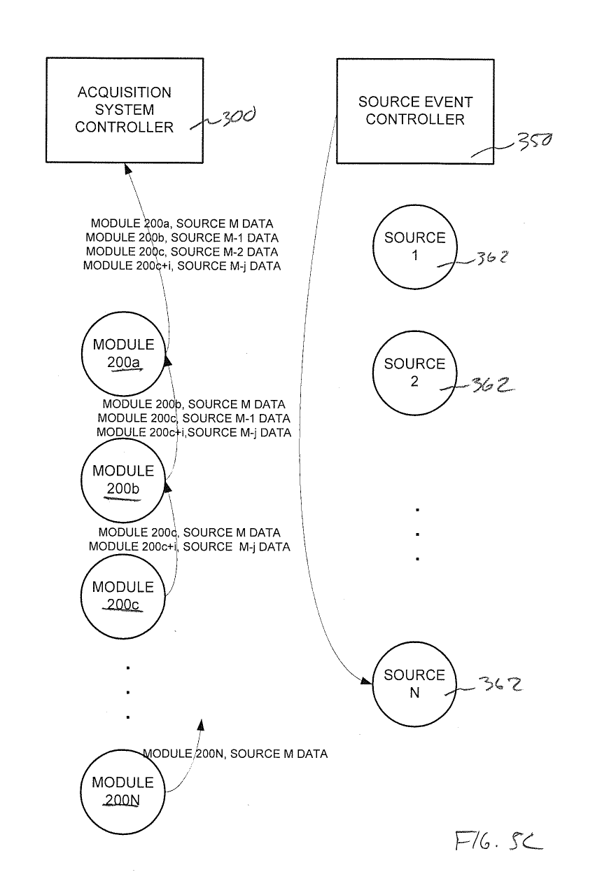

One embodiment of a method in which data may be transmitted among the modules is shown in FIGS. 5A-5C. In FIGS. 5A-5C, a plurality of modules 200a-200N may be deployed. The modules may communicate data from module 200N up the transmission path to the acquisition system controller 300. Furthermore, a source event controller 350 is shown that may activate various source events 360 (e.g., source event 1 through source event M).

In this regard, with reference to FIG. 5A, the source event controller 340 may activate source event 1. Accordingly, each module may record data corresponding to source event 1. The seismic data from all modules corresponding to source event 1 may be referred to as the seismic record for source event 1. Also shown in FIG. 5A is that each module 200a-200N passes along the data the next module in the transmission path. In this regard, the general nomenclature of (MODULE #, SOURCE EVENT #) is used to denote the data transmitted by each module 200a-200N. That is, module 200N transmits its data up the stream, module 200c transmits its data for source event 1 to module 200b, module 200b transmits its data for source event 1 to module 200a, and module 200a transmits its data to the acquisition system control 300.

In a second time period shown in FIG. 5B, the source event controller 350 may activate source event 2. In this regard, each module 200a-200N may collect data corresponding to source event 2. It will be appreciated, however, that not all modules have read out the data from source event 1 prior to the activation of source event 2. That is, the entire record for source event 1 may not yet be received at the acquisition system controller 300 at the time of source event 2. In this regard, as can be appreciated in FIG. 5B, module 200N transmits data corresponding to source event 2 up the transmission path. Module 200c transmits data collected at module 200c for source event 2 along with data corresponding to source event 1 collected from upstream module 200c+i to module 200b. Module 200b transmits data collected at module 200b for source event 2 along with data corresponding to source event 1 from module 200c to module 200a. Module 200a transmits data corresponding to source event 1 collected from module 200b along with data corresponding to source event 2 collected at module 200a to the acquisition system controller 300.

It will be appreciated the communication of this kind is continued for the number of source events M in the survey. In this regard, as shown in FIG. 5C, during some subsequent time period, source event M may be activated. In this regard, module 200N will transmit data corresponding to source event M up the transmission path. Moreover, module 200c will transmit data corresponding to previous source events M-j from upstream modules 200c+i to module 200b. It will be appreciated that the data corresponding to previous source events M-j from upstream modules 200c+i may correspond to a number of data portions collected at a plurality of modules for a plurality of source events. In any regard, module 200b transmits data corresponding to source event M recorded at module 200b along with data corresponding to source event M-1 collected at module 200c and data corresponding to previous source events M-j collected at upstream modules 200c+i to module 200a. Module 200a transmits data corresponding to source event M collected at module 200a to the acquisition system controller 300. Module 200a also transmits data corresponding to source event M-1 collected at module 200b, data corresponding to source event M-2 collected at module 200c, and data corresponding to previous source events M-j collected at upstream modules 200c+i to the acquisition system controller 300. It will be further appreciated that even after the completion of the source events 360, the modules 200a-200N may continue to transmit data until the seismic record for all source events 360 (i.e., source event 1 to source event M) is received at the acquisition system controller 300.

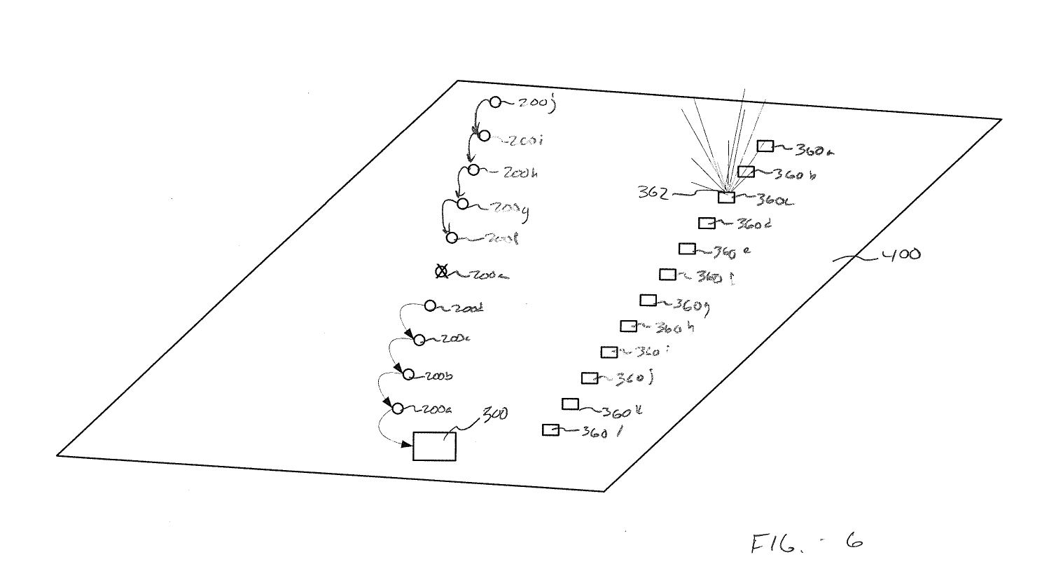

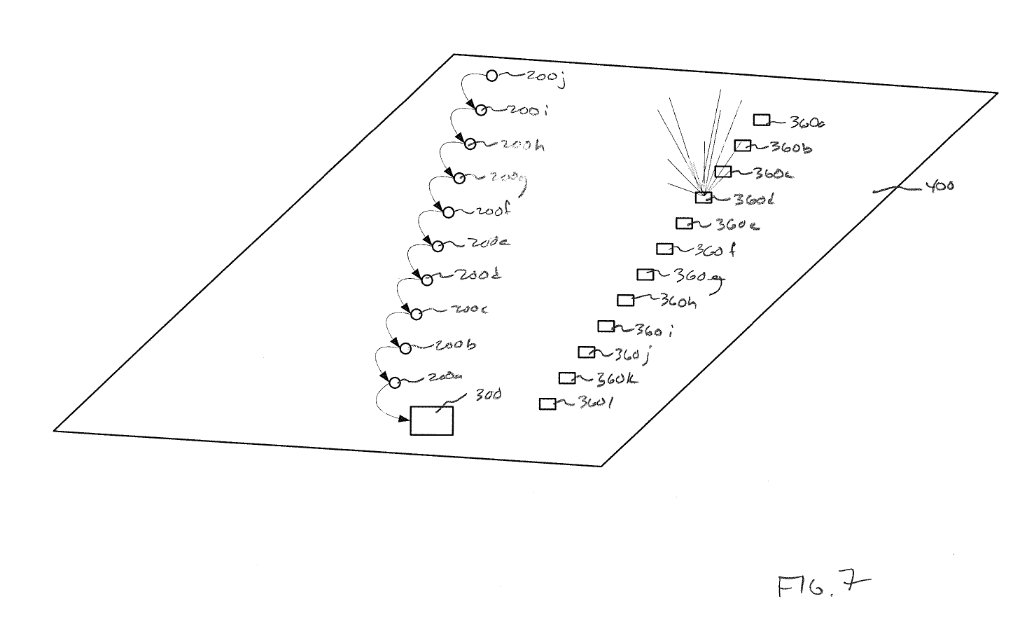

As stated briefly above, the modules 200 described herein may have features that help increase the likelihood of the data record being read out from the modules 200. For example, as described above, in addition to reading out data as shown in FIGS. 5A-5C, a copy of seismic data corresponding to a number of source events may be stored in a local data buffer of the module 200. In this regard, in the event of a failure in communication, such as the one shown in FIG. 6 where module 200e fails to communicate, at least a portion of the modules (e.g., modules 200e-200j) may store the data collected at subsequent source events 362 in a data buffer. The portion of the modules 200 downstream of the communication failure at module 200e may continue to read out to the acquisition system controller 300 in a manner described above. Furthermore, should communication be restored at module 200e, as is shown in FIG. 7, the data corresponding to the source event 362 at energy source 360c (i.e., the data that was read into the buffer of modules 200e-200j alone) may be communicated once communication is restored. It will be appreciated that the subsequent source event 362 at energy source 360d is not delayed even in the event of the communication failure at 200e.

Furthermore, while it is shown in FIG. 7 that communication with module 200e is reestablished, it will be appreciated that module 200e may be removed from the transmission path such that module 200f transmits directly to module 200d. In this regard, module 200e may continue to acquire data for subsequent source events 362 such that the data acquired at module 200e is read into the data buffer of module 200e. If communication is never reestablished with module 200e, the data from module 200e may be read manually (e.g., with a data retrieval mechanism known in the art such as removable memory, close-range radio frequency communication, etc.).

Furthermore, while in the survey system 100 described herein data is usually read from the modules 200 without halting or delaying the progression of source events 362, there may be certain interrupt conditions wherein the progression of source events 362 may be interrupted or delayed to assist in preserving data integrity. In this regard, it will be appreciated that in many seismic surveys, the amount of data recovered in the survey does not necessarily correspond to data for every source event at every data module. For example, a module may experience an error in the data acquisition equipment (e.g., the vibration sensor 201, signal processing components, etc.), the memory 205 or data buffer, or the transmission components of the module. In this regard, a threshold value may be established wherein data loss of the survey system that does not exceed the threshold is considered to be a compete record. The threshold value may represent a value that, if exceeded, represents a statistically significant data loss. As such, a loss of data integrity may result in a statistically significant loss of data.

For example, the status of the data buffers of each module 200 may be monitored to help reduce the potential that a buffer will not be overrun such that data that has not yet been read out is overwritten without being transmitted or being received by the acquisition system controller 300. For example, as described above, in the event of a fault within the serial transmission path among the modules 200, the modules may begin to write to a data buffer at the module 200. A minimum free buffer threshold may be determined. The minimum free buffer threshold amount may correspond to a predetermined minimum size of the buffer that is available at the module (i.e., to preserve data integrity in the case of a failure in communication). In this regard, the acquisition system controller 300 may receive information corresponding to the buffer status of each module 200. Should the amount of buffer fall below the predetermined free buffer threshold, the progression of source events 362 may be interrupted or delayed to allow the data buffer to return to a level above the minimum free buffer threshold.

Furthermore, an interrupt condition may be generated upon detection of errors or failure with a statistically significant portion of the modules. In this regard, the progression of the source events may be interrupted so that the modules may undergo troubleshooting. For example, the modules may be remotely reconfigured or replacement modules may be deployed to overcome the failures of modules in the array.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. A method for seismic data acquisition, comprising:
disposing, in series, a plurality of seismic data acquisition modules that are operative to wirelessly communicate acquired seismic data, wherein the acquisition modules define a wireless serial data transfer path for relaying data from upstream acquisition modules to downstream acquisition modules and a data collection unit;
creating a first source event;
acquiring first seismic data corresponding to the first source event at the plurality of seismic data acquisition modules to generate a first data record, the first data record comprising first seismic data collected at each one of the plurality of seismic data acquisition modules;
transmitting the first seismic data from at least one module on the serial data transfer path in a direction nearer the data collection unit; and
initiating a second source event, wherein the second source event occurs independent of the receipt of the first data record at the data collection unit.

2. The method according to claim 1, wherein the second source event occurs prior to receipt of the entire first data record at the data collection unit.

3. The method according to claim 1, further comprising continuing a source event progression of a plurality of sequential source events, wherein each source event in the source event progression occurs independent of the receipt of a data record corresponding to a previous source event in the source event progression at the data collection unit.

4. The method according to claim 3, further comprising:
interrupting the source event progression in response to an interrupt condition.

5. The method according to claim 4, wherein the plurality of data acquisition modules record the first seismic data in a data buffer at each respective acquisition module.

6. The method according to claim 4, wherein the transmitting comprises providing status information regarding the data buffer.

7. The method according to claim 6, wherein the interrupt condition is at least partially based on the buffer status information.

8. The method according to claim 2, further comprising:
retransmitting the first seismic data from at least one module on the serial data transfer path in a direction nearer the data collection unit at some time after the transmitting step.

9. The method according to claim 8, wherein the retransmitting step is in response to a request for the first seismic data.

10. A seismic survey system, comprising:
a data collection unit;
a plurality of data acquisition modules disposed in series that are operative to wirelessly communicate acquired seismic data, wherein the acquisition modules define a wireless serial data transfer path for relaying the seismic data from upstream acquisition modules to downstream acquisition modules and the data collection unit;
an acquisition system controller in operative communication with the plurality of data acquisition modules;
a source event controller operable to control the initiation of a plurality of source events, wherein the source event controller is in operative communication with the acquisition system controller to synchronize the acquisition system controller and the source event controller;
wherein the plurality of acquisition modules are operable to record seismic data corresponding to a source event initiated by the source event controller and initiate transmission of the seismic data along the serial transfer path toward the data collection unit, wherein the seismic data collectively comprises a seismic record corresponding to the seismic data recorded at each of the plurality of acquisition modules for the source event; and
wherein the source event controller is operable to initiate another source event independent from receipt of the seismic record corresponding to the source event at the data collection unit.

11. A method of conducting a seismic survey, comprising:
disposing, in series, a plurality of seismic data acquisition modules that are operative to wirelessly communicate acquired seismic data, wherein the acquisition modules define a wireless serial data transfer path for relaying data from upstream acquisition modules to downstream acquisition modules and a data collection unit;
initiating a source event progression, wherein the source event progression includes a plurality of source events activated in sequence independent of data acquisition by the plurality of modules;
collecting seismic data at the plurality of seismic data acquisition modules during the source event progression, wherein the seismic data corresponding to the plurality of source events is transmitted along the serial data transfer path nearer the data collection unit; and
interrupting the source event progression in response to an indication of loss of data integrity.
